(19) United States
(12) Patent Application Publication
(10) Pub. No.: US 2017/0213190 A1
(43) Pub. Date: Jul. 27, 2017

(54) METHOD AND SYSTEM FOR ANALYSING SUBJECTS

(71) Applicant: INTERVYO R&D LTD., Tel- Aviv (IL)

(72) Inventor: Jacky HAZAN, Tel- Aviv (IL)

(21) Appl. No.: 15/321,217

(22) PCT Filed: Jun. 23, 2015
(86) PCT No.: PCT/IL2015/050642

§ 371 Date: Dec. 22, 2016

Related U.S. Application Data
(60) Provisional application No. 62/015,555, filed on Jun. 23, 2014.

(51) Int. Cl. G06Q 10/10; G10L 25/63; G09B 19/00; G10L 15/22; G09B 7/06; G06F 17/30; G10L 15/18

(52) U.S. Cl. CPC G06Q 10/1053; G06F 17/30817; G06F 17/30864; G10L 25/63; G10L 15/1815; G10L 15/22; G09B 7/06; G09B 19/00

(57) ABSTRACT

Disclosed are methods and systems that perform an interview of an interviewee and provide a score for that interviewee based on numerous characteristics of the interviewee from the interview. The invention provides an automated interactive communication system, method, and software application, by which any individual may be able to converse, interact, and conduct a dialogue with a number of pre-set video recordings using an individual's vocal speech as one of its main input sources, and having the system output intelligently timed and programmed natural human-like responses via audio video recordings, in relation to the contextual input provided by the individual and as analyzed by the system.

### CROSS REFERENCES TO RELATED APPLICATIONS

This application is related to and claims priority from commonly owned U.S. Provisional Patent Application Ser. No. 62/015,555, entitled: Method and System for Analyzing Subjects, filed on Jun. 23, 2014, the disclosure of which is incorporated by reference in its entirety herein.

### TECHNICAL FIELD

The present invention relates to methods and systems for analyzing interviewees and scoring their interview.

### BACKGROUND

Employers interview countless numbers of candidates, by in person and telephone interviews. This process has a high soft cost, as present employees and business owners must take time away from their work to conduct the interviews. Additionally, this conventional form of interviewing results in many bad hires, costing the company money to again interview, rehire and train the hired employee.

### SUMMARY OF THE INVENTION

Embodiments of the invention are directed to a computer-implemented method for evaluating a subject, for example, a user or interviewee. The method comprises: providing, in a prerecording delivered over a communications network (e.g., the Internet, cellular networks, wide area networks and local area networks and combinations thereof) to a display device associated with a subject, at least one statement, as integrated audio and video, to the subject; recording the subject in both audio and video in responding to the statement; analyzing the audio and video for at least one characteristic of the subject; and, providing an evaluation of the subject based on the analysis of the at least one characteristic.

Optionally, the at least one statement includes at least one prerecorded interview question which is being presented by a visible interviewer in the prerecording, in an interview with the subject.

Optionally, the at least one prerecorded interview question includes a plurality of prerecorded interview questions which are being presented by the visible interviewer.

Optionally, the plurality of prerecorded interview questions are defined by a list and are of multiple question types, the questions selected prior to the interview based on the position for interview is being conducted.

Optionally, the order of presenting the prerecorded interview questions is in accordance with an analysis of the audio and video of the answer to the previous prerecorded interview question.

Optionally, the presenting the prerecorded interview questions is terminated in accordance with an analysis of the audio and video of the answer to the previous prerecorded interview question.

Optionally, the presenting and terminating of the presenting of the prerecorded questions is performed in real time.

Optionally, the analyzing the audio and video for at least one characteristic of the subject, is performed on recorded audio and video files taken of the subject while responding to the questions.

Optionally, the evaluation of the subject is presented as at least one of: a candidate score for the subject, and, a recommendation or non-recommendation of the subject for the position for which the interview was conducted.

Optionally, the display device associated with the subject is a computer including a monitor linked to the communications network, a camera for recording the video associated with the subject and a microphone for recording the audio associated with the subject.

Embodiments of the invention are directed to a system for evaluating a subject. (e.g., a computer user, am interviewee). The system comprises: first storage media for storing interviews for at least one position including a plurality of prerecorded questions for presentation to a subject over a communications network to a display and audio and video recording device associated with the subject, as integrated audio and video; a processor; and, second storage media storage media in communication with the processor for storing instructions executable by the processor. The instructions comprise: presenting prerecorded questions as integrated audio and video to the subject over the communications network to the display and audio and video recording device associated with the subject; recording the subject in both audio and video in responding to the prerecorded questions; analyzing the audio and video for at least one characteristic of the subject; and, providing an evaluation of the subject based on the analysis of the at least one characteristic.

Other embodiments of the invention are directed to a computer usable non-transitory storage medium having a computer program embodied thereon for causing a suitable programmed system to provide an evaluation of a subject, by performing the following steps when such program is executed on the system. The steps comprise: obtaining, from storage media, at least one stored prerecorded interview for at least one position including a plurality of prerecorded questions for presentation to a subject over a communications network, to a display and audio and video recording device associated with the subject, as integrated audio and video; presenting prerecorded questions as integrated audio and video to the subject over the communications network to the display and audio and video recording device associated with the subject; recording the subject in both audio and video in responding to the prerecorded questions; analyzing the audio and video for at least one characteristic of the subject; and, providing an evaluation of the subject based on the analysis of the at least one characteristic.

Other embodiments of the invention are directed to a method for interviewing a subject. The method comprises: obtaining a plurality of prerecorded questions for presentation to an interview subject over a device linked to a communications network in an integrated audio and video format; presenting a first question from the plurality of prerecorded questions to the subject via the device; analyzing at least the audio received from the subject via the device over the communications network, for the end of the answer to the first question; and, based on the analysis, performing at least one of: presenting a subsequent question from the remaining plurality of prerecorded questions, or terminating the presenting of the prerecorded questions.

Optionally, the analyzing includes further analyzing at least the audio received for the answer, and based on the further analysis, determining which question of the remaining plurality of prerecorded questions is to be presented to the subject.

Optionally, the analyzing includes further analyzing at least the audio received for the answer, and based on the further analysis, determining to terminate the presenting of the prerecorded questions.

Optionally, the further analysis includes a contextual analysis of the answered prerecorded question.

Optionally, the presenting the first question from the plurality of prerecorded questions to the subject via the device; and the analyzing at least the audio received from the subject via the device over the communications network, for the end of the answer to the first question, are performed in real time.

Optionally, the device associated with the subject is a computer including a monitor linked to the communications network, a camera and a microphone.

Other embodiments of the invention are directed to a system for evaluating a subject. The system comprises: first storage media for storing interviews for at least one position including a plurality of prerecorded questions for presentation to a subject over a communications network to a display and audio and video recording device associated with the subject, as integrated audio and video; a processor; and, second storage media storage media in communication with the processor for storing instructions executable by the processor. The instructions comprise: presenting a first question from the plurality of prerecorded questions to the subject via the device; analyzing at least the audio received from the subject via the device over the communications network, for the end of the answer to the first question; and, based on the analysis, performing at least one of: presenting a subsequent question from the remaining plurality of prerecorded questions, or terminating the presenting of the prerecorded questions.

Optionally, the instructions additionally comprise: further analyzing at least the audio received for the answer, and based on the further analysis, determining which question of the remaining plurality of prerecorded questions is to be presented to the subject.

Optionally, the instructions additionally comprise: further analyzing at least the audio received for the answer, and based on the further analysis, determining to terminate the presenting of the prerecorded questions.

Optionally, the further analysis includes a contextual analysis of the answered prerecorded question. Embodiments of the invention are directed to a computer usable non-transitory storage medium having a computer program embodied thereon for causing a suitable programmed system to provide an evaluation of a subject, by performing the following steps when such program is executed on the system. The steps comprise: obtaining a plurality of prerecorded questions for presentation to an interview subject over a device linked to a communications network in an integrated audio and video format; presenting a first question from the plurality of prerecorded questions to the subject via the device: analyzing at least the audio received from the subject via the device over the communications network, for the end of the answer to the first question: and, based on the analysis, performing at least one of: presenting a subsequent question from the remaining plurality of perecorded questions, or terminating the presenting of the prerecorded questions.

This document references terms that are used consistently or interchangeably herein. These terms, including variations thereof, are as follows.

Throughout this document, a “web site” is a related collection of World Wide Web (WWW) files that includes a beginning file or “web page” called a home page, and typically, additional files or “web pages.” The term “web site” is used collectively to include “web site” and “web page(s).”

A uniform resource locator (URL) is the unique address for a file, such as a web site or a web page, that is accessible over Networks including the Internet.

A “computer” includes machines, computers and computing or computer systems (for example, physically separate locations or devices), servers, computer and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., smartphone, personal digital assistant (PDA), mobile telephone or cellular telephone).

A server is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine, a software based emulation of a computer.

An “application”, includes executable software, and optionally, any graphical user interfaces (GUI), through which certain functionality may be implemented.

A “client” is an application that runs on a computer, workstation or the like and relies on a server to perform some of its operations or functionality.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIGS. 1A and 1B are diagrams of an exemplary environment for the system in which embodiments of the disclosed subject matter are performed;

FIG. 2A is a diagram of the architecture of the home server of FIGS. 1A and 1B and the system thereof;

FIG. 2B is a diagram of the Verbal Analysis Engine of FIG. 2A;

FIG. 2C is a diagram of the Non-Verbal Analysis Engine of FIG. 2A;

FIG. 2D is a diagram of the Vocal Analysis Engine of FIG. 2A:

FIG. 3 is a flow diagram of processes in accordance with embodiments of the disclosed subject matter:

FIG. 4A is a flow diagram of block 304 of FIG. 3;

FIG. 4B is a flow diagram of block 308 of FIG. 3; and,

FIG. 5 is a flow diagram of an exemplary process performed by a machine learning system and scoring module in accordance with embodiments of the invention.

### DETAILED DESCRIPTION OF THE DRAWINGS

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways, for various business applications in various industries.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more non-transitory computer readable (storage) medium(s) having computer readable program code embodied thereon.

Throughout this document, numerous textual and graphical references are made to trademarks, and domain names. These trademarks and domain names are the property of their respective owners, and are referenced only for explanation purposes herein.

The present invention utilizes the technology of NLP (Natural Language Processing), speech recognition, semantic analysis, and the science and technology of spatial (non-verbal) human bio-metric analysis, to perform an interview of an interviewee and provide a performance analysis and score for that interviewee based on numerous characteristics of the interviewee from the interview. The invention provides an automated interactive communication system, method, and software application, by which any individual may be able to converse, interact, and conduct a dialogue with a number of pre-set video recordings using an individual's vocal speech as one of its main input sources, and having the system output intelligently timed, synchronized, and programmed natural human-like responses via audio video recordings, in relation to the contextual input provided by the individual and as analyzed by the system.

The invention, in some embodiments includes a multi-dimensional engine, method, and system that allows for human-computer interaction of intelligent contextually based conversational simulations between a human individual (the user or interviewee), and one or more pre-recorded videos (of a human interviewer), to be used primarily but not limited to the purpose of conducting a highly interactive and completely automated job interview simulation. Embodiments of the present invention provide numerous applications.

For example, embodiments of the invention provide individuals (job seekers, e.g., interviewees, the ability to practice their job interviewing skills, utilizing the system's automated interviewing platform, and in addition to receive a comprehensive interviewing performance analysis and rating/score, based on a wide range of verbal and non-verbal (spatial) bio-metric inputs analyzed by the system.

Also, for example, the invention provides professional organizations (private/public companies/firms/corporations/recruiters) with the ability to have their job applicants conduct a completely automated job interview (either remotely or on-premise) utilizing the platform, in order to assist their recruiting staff in determining which of the proposed job applicants are most suitable for the position, based on the comprehensive verbal and non-verbal candidate performance analysis (rating/score) generated by the system, and based on all other analysis tools and methods conducted by the system.

Also, for example, the invention provides professional organizations (private/public companies/firms/corporations/recruiters) with the ability to have their job applicants conduct a live remote video conference job interview, with the recruiting manager, utilizing the platform, in order to assist their recruiting staff in determining which of the proposed job applicants are most suitable for the position, and have the system analyze the candidate during the live remote video conference job interview, based on the comprehensive verbal and non-verbal candidate performance analysis (rating/score) generated by the system, and based on all other analysis tools and methods conducted by the system

The system and method is operable as either a web/browser based and/or PC/Tablet/Mobile client based on a software application. This allows users of the system of the invention to access the system via either of the leading on-line and off-line technological platform options, i.e. via a web based browser on PC's, laptops, or mobile devices (tablets or handhelds/smart-phones), and via a mobile client based application running on leading operating systems, for example, iOS from Apple®, Android, or Windows®.

The system may use third party websites (who offer an API), for example, Linkedin. Google+, Twitter, to provide a login mechanism and account credential authentication. These third party websites may also be used to retrieve data on the interviewee and integrate this information within the system, either to generate a user profile or to be used for scoring purposes within any of the system engines used to analyze and provide a score on the candidate's (interviewee's) performance.

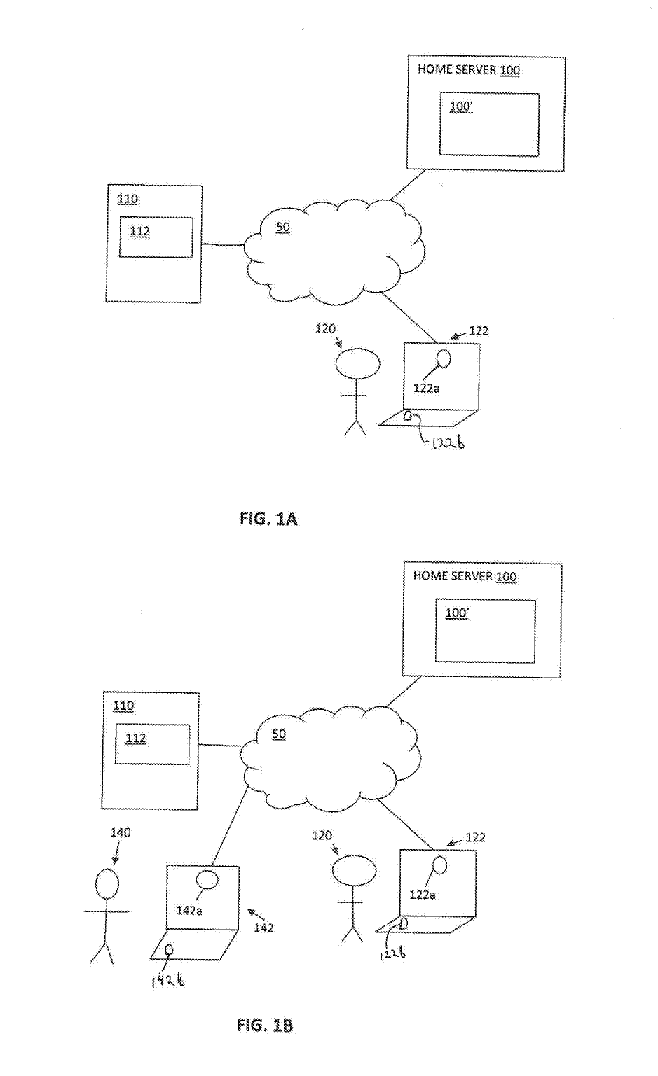

Reference is now made to FIG. 1A, which shows an exemplary operating environment for an automated interview. The environment includes a network 50, to which is linked a home server (HS) 100, also known as a main server. The home server 100 also defines a system 100′, either alone or with other, computers, including servers, components, and applications, e.g., client applications, associated with either the home server 100, as detailed below. The network 50 is, for example, a communications network, such as a Local Area Network (LAN), or a Wide Area Network (WAN), including public networks such as the Internet. As shown in FIG. 1A, single network, may be a combination of networks and/or multiple networks including, for example, cellular networks. “Linked” as used herein includes both wired or wireless links, either direct or indirect, and placing the computers, including, servers, components and the like, in electronic and/or data communications with each other.

The various servers linked to the network 50, include, for example, a cloud server 110 on which is stored an interactive application 112, known as the HR Administration application. The application 112 may be part of the system 100′.

The user or interviewee 120, via his computer 122 is also linked to the network 50. The link to the network 50 is by either phone. e.g., cellular, or data, a computer, such as a desktop, laptop, tablet, ipad®, or the like. The computer 122 of the user 120 includes, for example, a camera 122a, and a microphone 122b.

FIG. 1B shows an alternative environment for the invention, for live interviews. This environment is the same as that of FIG. 1A, except that there is an interviewer 140, with his computer 142, who conducts a live interview with the user 120, at the user's computer 122. The computer 142 of the interviewer 140n also includes, for example, a camera 142a, and a microphone 142b.

The home server (HS) 100 is of an architecture that includes one or more components, engines, modules and the like, for providing numerous additional server functions and operations, and, for running the processes of the system 100′ of the invention. The home server (HS) 100 may be associated with additional storage, memory, caches and databases, both internal and external thereto. For explanation purposes, the home server (HS) 100 may have a uniform resource locator (URL) of, for example, www.hs.com. While a single home server (HS) 100 is shown, the home server (HS) 100 may be formed of multiple servers, computers, and/or components.

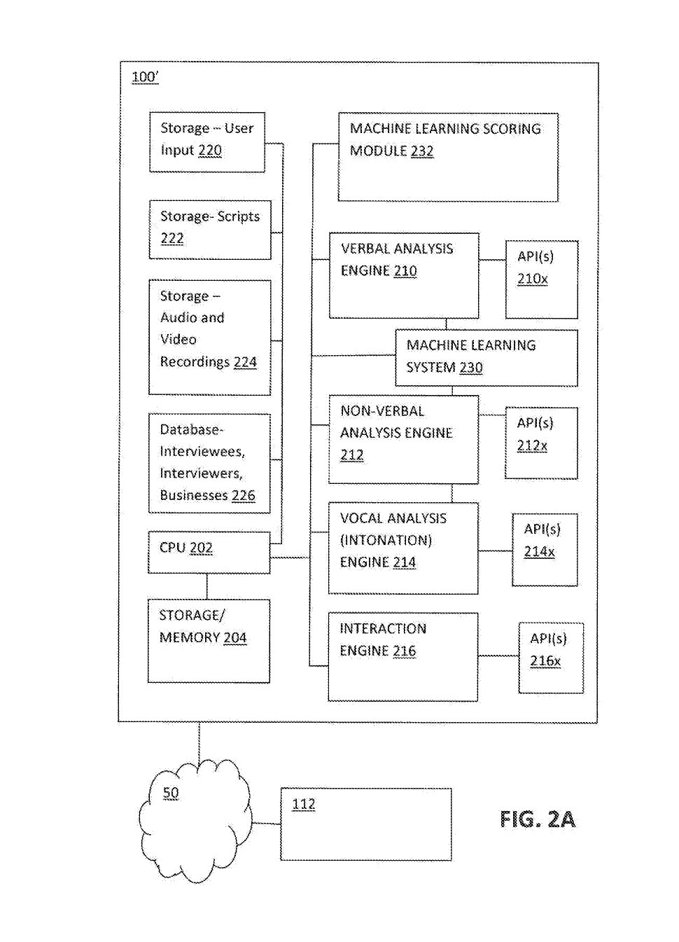

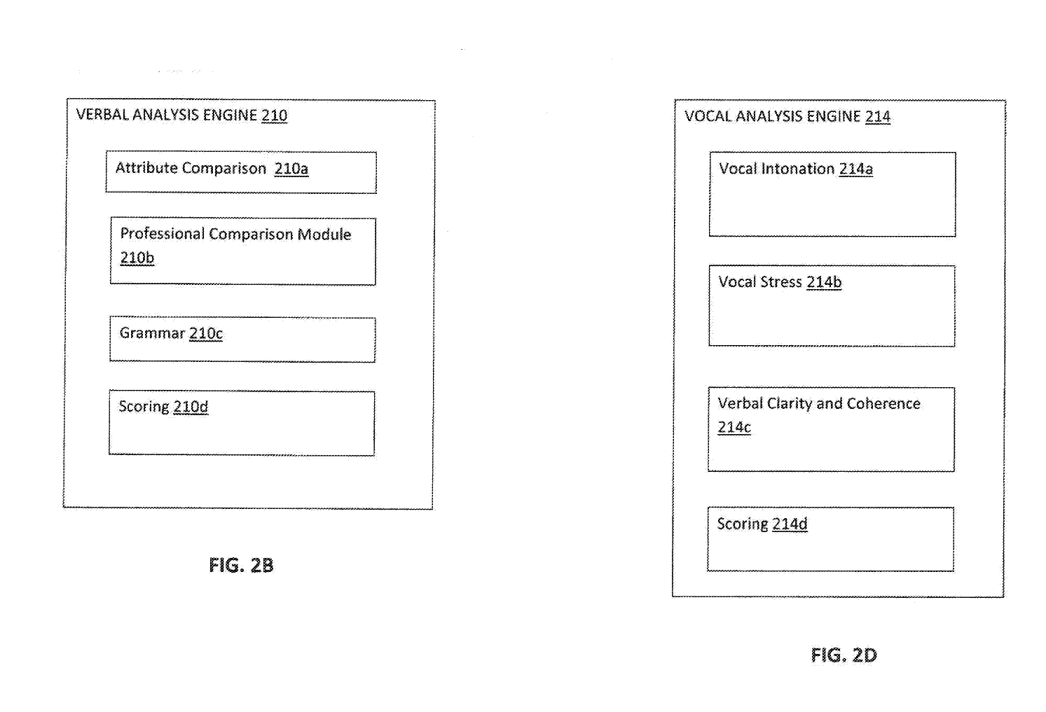

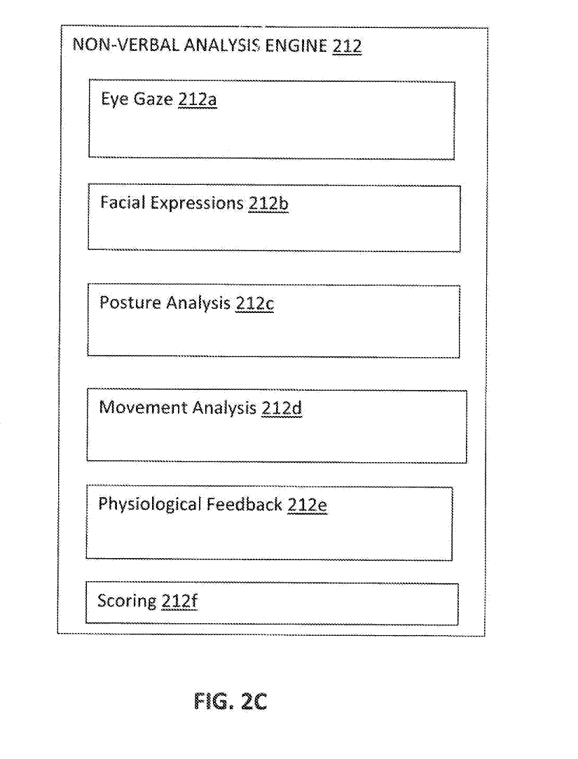

Attention is now directed to FIG. 2A, which shows the architecture of the system 100′, for example, in the home server 100. This architecture of the system 100′, as shown, for example, in the home server 100, includes a central processing unit (CPU) 202 formed of one or more processors, electronically connected, including in electronic and/or data communication with storage/memory 204. The CPU 202 also communicates electronically and/or data, to engines, including, for example, a verbal analysis engine 210, a non-verbal analysis engine 212, a vocal analysis/intonation engine 214, and an interaction engine 216. Each of the engines 210, 212, 214, 216 is in electronic and/or data communication with one or more APIs (application programming interfaces) 210x, 212x. 214x, 216x. Storage media, including databases also connect electronically and/or data, to the CPU 202, and include, for example, storage for user (interviewee) inputs 220, scripts 222, and video recordings of interviews by various interviewers for various positions (e.g., jobs or employment) 224. There are also machine learning components—a machine learning system 230 and a machine learning scoring module 232. All of the aforementioned components of the system 100′ communicate with each other, electronically and/or data, either directly or indirectly. This also holds true for the HR Admin. 112 in the cloud server 110, with the aforementioned components of the system 100′.

The HR Admin 112, for example, in cloud server 110, stores, for example, company (the company doing the interviewing) data, candidate (user or interviewee) data, candidate profiles, for example, as taken from web pages, social media and the like, customer (e.g., company) account details, videos for the interviews, feedback and comments on various candidates, and the like.

Storage media 220 is also suitable for storing, for example, speech to text transcripts for interviewees (and in some cased interviewers, when the interview was a live interview), analyses, candidate profile data and company information.

The Central Processing Unit (CPU) 202 is formed of one or more processors, including microprocessors, for performing the home server 100 and system 100′ functions and operations detailed herein, including controlling the engines, 210, 212, 214, and 216, storage media 220, 222 and 224, and machine learning components 230, 232. The processors are, for example, conventional processors, such as those used in servers, computers, and other computerized devices. For example, the processors may include x86 Processors from AMD and Intel, Xenon® and Pentium® processors from Intel, as well as any combinations thereof.

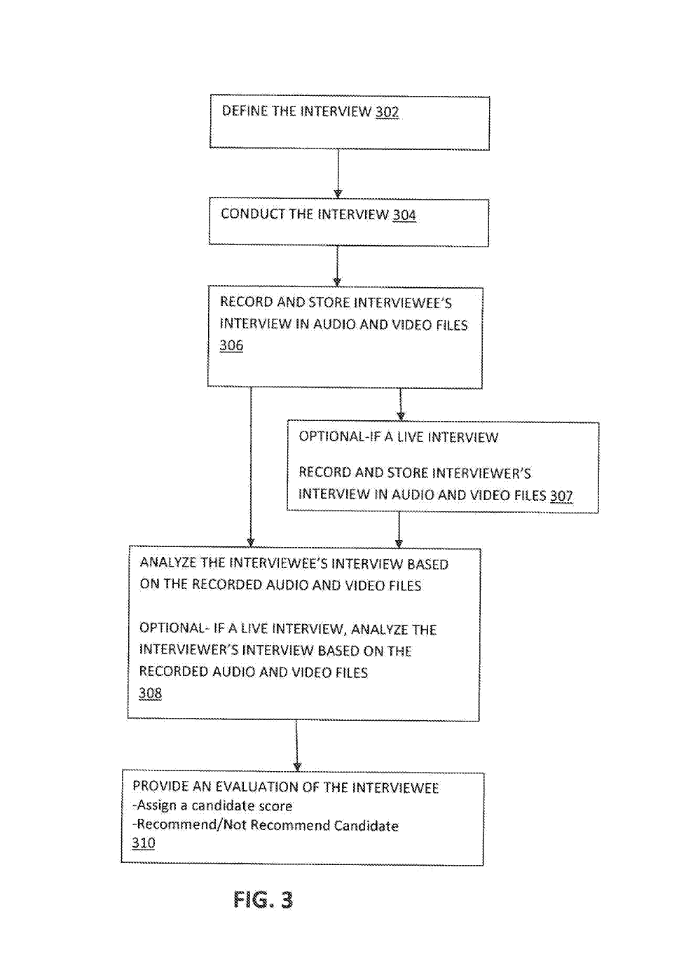

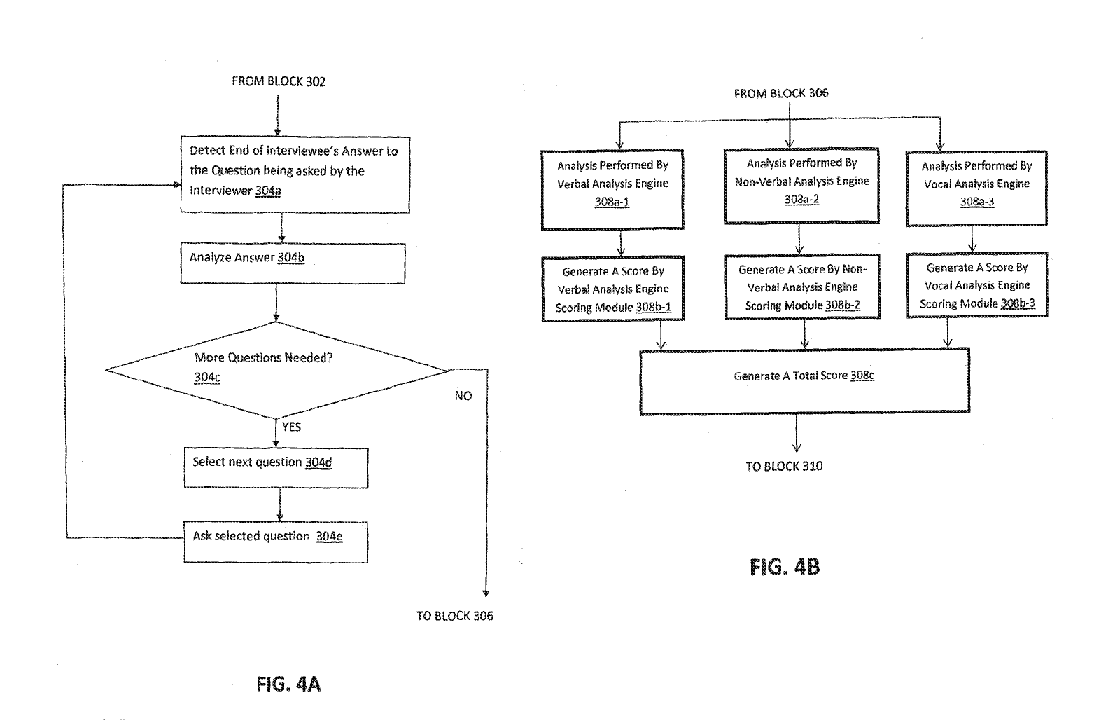

The storage/memory 204 is any conventional storage media. The storage/memory 204 stores machine executable instructions for execution by the CPU 202, to perform the processes of the invention. The storage/memory 204 also includes machine executable instructions associated with the operation of the components, including the engines, 210, 212, 214, and 216, and storage media 220, 222 and 224. API 210, communications module 212, message administration module 214, databases 216, and applications 220, and all instructions for executing the processes of FIGS. 3 and 4, detailed herein. The storage/memory 204 also, for example, stores rules and policies for the system 100′ and the home server 100. The processors of the CPU 202 and the storage/memory 204, although shown as a single component for representative purposes, may be multiple components, and may be outside of the home server 100 and/or the system 100′, and linked to the network 50.

### Verbal Analysis Engine 210

The verbal analysis engine 210 functions, for example, to analyze and interpret all human verbal input provided by the user (e.g., interviewee) (via speech to text), and rates that input respectively, to provide a performance score for the user for the verbal analysis portion of the interview. The verbal analysis engine analyzes a varied list of important verbal metrics that are utilized to determine the verbal analysis score (of the total interview score). If desired, the verbal analysis score may be used solely as the overall interview score. Alternatively, in cases where the user (interviewee) suffers from impaired speaking or hearing disabilities, the score from the verbal analysis engine 210 may be disregarded altogether, with the score determined from non-verbal parameters. Also, the score from the verbal analysis engine 210 may be weighted, when combined with scores from one or more of the other engines 212, 214. For example, this weighting may occur when key factors of one specific parameter is preferred over another.

The verbal analysis engine 210 includes an API 210x, which initially converts the stored speech (audio) for the interview, e.g., for the interviewee, in the case of the automated interview, and additionally, for the interviewer, in the case of the live interview, from the audio file of the interview in the storage 220. The API 201x converts the speech to text by NLP (Natural Language Processing) and other speech recognition technologies, and text analysis methods, via one or more APIs for example, Web Speech Recognition API; Nuance Dragon Naturally Speaking; IBM Watson speech recognition API. The aforementioned speech to text tools transfer the user's (interviewee's) answers and/or responses (the human vocal/sound input) into textual sentences. The users (interviewees) of the system 100′ are not required to, and do not necessarily, interact with the system 100′ using common video commands (play/pause/stop) to interact with the system's 100′ automated interviewer. Rather, the analyzed sound input of the user causes the system 100′ to best respond and react accordingly. Also, the user's sound/vocal input may be registered into the system 100′ by any type of working microphone, usually a built-in/integrated microphone, e.g., 122b, within the computer 122 on which the interview is conducted. The verbal analysis engine 210 then scouts/parses the textual sentences from the vocal input for specific phrases: keywords; engrams; and/or one/or more keyword combinations and natural language processing techniques, in order to turn the textual sentences into meaningful commands that the engine 210 can interpret, understand and use the converted text, for analysis, as detailed herein.

Additional APIs 210x used with the verbal analysis engine 210 include, for example, Alchemy API Sentiments, to determine the sentiment or mood of the user (e.g., interviewee), such as happy, sad, concerned, combative, and the like. Additionally, Whitesmoke API is used to assess the level of the language spoken by the user (e.g., interviewee), and IBM Watson Personality Insights API, for assessing psychological traits or attributes based on the “Big 5” model, the “values” model, and the “Needs” model. These results are provided to the scoring module 210d, and factored into the overall score from the verbal analysis engine 210.

The verbal analysis engine 210, via modules 210a-210d and APIs 210x, analyzes the text of the user's (e.g., interviewee's) verbal/vocal/voice input, as stored in the audio file of the interview. The analysis is of at least one parameter from a plurality of parameters, listed immediately below. Each of the verbal analysis parameters used to analyze the performance of the user has its own particular scoring method and relevant adjustable weight (importance and/or priority) in relation to the question being asked by the system's interviewer. The scoring results are taken into the calculation within the final analysis. Verbal analysis parameters include, for example, the following parameters, as provided in the following modules, shown in detail in FIG. 2B:

### 1. Attributes Comparison Module 210a.

This module 210a is based on the rationale of combining the HR (Human Resources) field methods with psychology field methods for assessment and analyzing the data gathered using computational and non-biased methods

This module 210a conducts the psychological evaluation using professional assessment data, allowing for higher reliability and accuracy. Furthermore, this combination of adding the data analysis tools, creates data useful for the analysis by this engine 210. The learning ability of the module 210a allows for the development of a prediction model for each job for which an interview by the system 100′ will be conducted. For example, the model can identify that a recruitment for vast knowledge for a specific position is less important than creativity skill in order to do the job successfully, in contrast to the common norm.

In order to establish the model, it was assumed that different jobs requires different diagnosis processes. This means that instead of creating just one diagnostic tool and alternating its criteria and predictions according to each profession, a custom diagnosis is created for each profession. That is according to an elaborated job analysis procedure that produces the prediction criteria according to the specific job. Later, the criteria is translated into a specific set of questions and tasks. Also, for each job, a specific method for evaluating the given answer is developed. Furthermore, analysis using a variety of data analysis tools is made. For example, on data driven from the question, an intonation, eye gaze, facial expression and expressiveness analysis is made (by the non-verbal engine 212). In order to produce additional data then that driven from the semantic analysis of the answer itself. A kind of data that can't be produce and coded by a human estimator. In addition, the information gathered can be compared in a relative manner between all the candidates, a comparison that a human estimator cannot make, without neglecting and biasing substantial amounts of important information.

The job analysis method was developed in the early 20th century and is part of the industrial-organizational (I-O) psychology field. It is a family of procedures to identify the content of a job in terms of activities involved and attributes or job requirements needed to perform the activities. It is widely used by HR officers and psychologists, both in the public and private sectors. The process takes into consideration relevant data and professionals' opinions regarding the job in order to deduct what are the main knowledge, skills, abilities and other characteristics (KSAOs) (Knowledge, Skills. Attributes, Other Characteristics) needed to complete the job successfully (Delegated Examining Operations Handbook, 2007), specifically, the top features for each category. Those top features are cross sectioned in order to get a concise and clear picture. This is being done according to the OPM method, and is based on O*NE database of occupational information. Later, The KSAOs features are categorized according to behavioral and non-behavioral features. An additional organizational citizenship behavior criteria is analyzed based upon the collected data (Kristof-Brown, A., & Guay, R. P. (2011). Person-environment fit).

The next step is to understand which of the API tools are relevant in the assessment of each KSAOs. For example, the technical tool of facial expression can be relevant in the assessment of the overall motivation of the candidate. Based upon many psychology evaluation tools and methods, like the Big 5, emotional intelligent, self-efficacy, and the like (Furnham, A. (1996). The big five versus the big four: the relationship between the Myers-Briggs Type Indicator (MBTI) and NEO-PI five factor model of personality, in, Personality and individual Differences, 21(2), 303-307; and, Furnham, A., Jackson, C. J., & Miller, T. (1999), Personality, learning style and work performance, in Personality and Individual Differences, 27(6). 1113-1122), and their implementation. At the same time KSAOs features are translated into measurable ones, that is, into insightful interview questions. Eventually this yields out a set of differentiated and comprehensive questions and tasks in specific combination that best reflects the profession's KSAOs, and allows to conduct the most insightful and efficient interview for the job (Campion, M. A., Campion, J. E., & Hudson. J. P. (1994), Structured interviewing: A note on incremental validity and alternative question types, in, Journal of Applied Psychology, 79(6), 998).

An additional set of tasks related to the profession is also developed. This set of tasks is developed to estimate the candidate abilities regarding the specific job, keeping in mind that preforming on task can provide a different type of data then the interview questions part. Again, the relevant API's are matched. The data collected here is analyzed in order to provide a more comprehensive evaluation.

Next, a method for evaluating and scaling the answers\performants for each item in the interview is developed (Structured Interviews: A Practical Guide, US, 2007). The developed process is based on the assumption that the evaluation should reflect whether an answer makes a good manifestation of the subject the question initially is trying to check, or not. This, then, must be go through decomposition analysis, in order to yield out an evaluating scale that can be translated into machine learning techniques in order to allow the atomization of the process. Each of the KSAOs features is being assessed with all the tools that can assess it— answer score, API, task score (for example, Organization skill is being assess through the Big Five ‘conscientiousness’ score, high quality answer in the question measuring this skill and working style as it shows in the job knowledge tasks) in order to produce a comprehensive final score.

A further analysis of non-direct features is being made in order to identify and understand an additional processes that is performed, during the interview, as a whole and per question or per task. That, in addition to the assessment of the specific KSAOs, in order to produce a sense of the interview process.

The combination of the methods from the different fields using a variety of API's combined with the ability to analyze a more relevant, reliable, massive amount of data in a precise, comparative and non-biased way, with constant learning and fine tuning of the model, is the outcome of the process described.

A scale example is now provided.

Competency: Interpersonal skills (Taken from US OPM. 2008)

Definition: a person who shows understanding, friendliness, courtesy, tact, empathy, concern and politeness to others. Develops and maintains effective relationships with others. May include effectively dealing with individuals who are difficult, Hostile or distressed. Relates well to people from varied backgrounds.

Question: describe a situation in which you had to deal with individuals who are difficult, Hostile or distressed. Who was involved? What specific actions did you take and what was the result?

| | | Answer's | |
|---|---|---|---|
| Answer | | evaluation | |
| level | Answer example | method | A person who |
| 5 excellent | “presented shortcomings | Creating an an | Have very high interpersonal |
| | of a newly installed | open envierment | skills. Serves as key resource |
| | automation system in a | that can dill with | and advises others. |
| | tactful manner to irate | conflicts and | Applies the competency in |
| | senior management | diffuses them. | exeptionally difficult |
| | officials” | | situations. |
| 4 advanced | “I have identified and | Identifies stress | Have advanced interpersonal |
| | emphasized common | soursess and | skills, Applies the |
| | goals to promote | dealls with | competency in considerably |
| | cooperation between HR | conflicts | difficult situations. |
| | and liine staff.” | | |
| 3 good | “I was able to remain | Can regulate and | Have good interpersonal |
| | courteous and tactful | deal with | skills. Applies the |
| | when confronted by an | “loaded” | competency in difficult |
| | employee who was | emotions | situations. |
| | frustrated by a payroll | | |
| | problem.” | | |
| 2 basic | “worked with others to | cooperate with | Applies the competency in |
| | minimize disruptions to | another person's | somewhat difficult situations. |
| | an employee that worked | good initiative. | |
| | under tight deadlines.” | | |
| 1 marginal | “when someone adress | Showes little | Applies the competency in |
| | me with a problam, I | involvment in the | simplest situations. |
| | refer him to the | team. | |
| | appropriate staff member | | |
| | to resolve their issue.” | | |

Professional Comparison Module 210b: The verbal content of the user's response is measured for contextualization in relation to the desired answer, i.e. how well or how close did the user respond verbally in relation to the expected answer and as compared or in relation to other users who have also responded to the same or similar question, or in relation to a data set of resumes for a particular position. Answer context is measured by but not limited to the following methods:

1. Content Structure: Organization, hierarchy and/or placement of one or more words or combination of words within a single or more sentences or phrases, as expected by the system in relation to the question being asked by the system's interviewer. For example, if a user is asked to speak about his/her professional background, the correct structure for the answer should be (according to research to which it is compared and scored): The user should begin by speaking about their professional background (starting with the most recent or relevant experience and moving down to the least recent or least relevant), then the user should speak about their academic background (starting from the most recent), and finally about their professional and personal achievements, and lastly and optionally about their personal interests. Note, for certain questions such as the one described here, the system may possibly tap into a third party online social network, (i.e., the user's Linkedin™ profile) to either corroborate or better understand the relevance of stated answer.
2. Occupational Compatibility: An answer that can assess the suitability of a user's professional and personal experience for the defined position/role for which the user is being interviewed by the system. For example, if a user is asked to speak about his/her professional strengths for a sales position, the system would expect that the user would answer (according to research to which it is compared and scored) the following traits: Persuasiveness, Sociability. Extrovertedness, then the system can conclude that these qualities match the system's designated answer. The same would be true for qualities which would not reflect the qualities of a proficient sales person, and would affect the score respectively. Note occupational compatibility may also take into consideration personal/psychological traits/qualities.
3. Professionalism Level: Used to assess the professional proficiency level/s or aspect/s of the user in direct relation to the title/position/role to which the user is being interviewed for by the system. For example, amount of years of experience, the form or method in which the user has conducted him/herself in various professional situations, and direct professional aptitude or level of mastery in the particular field/profession to which the user is being interviewed for.

The Professional comparison module 210b, also performs a process known as “semantic hashing.” Semantic hashing enables the association of each text document with a representation in 2D (two dimensions) or 3D (three dimensions). The algorithm performed by this module 210b uses a deep AutoEncoder to compute points on the representations. A list is then kept of the points of minimal distance to the Ideal Profile point. This short list will be the candidate ideal list.

The tool for semantic hashing was built by retrieving approximately 30,000 resumes from the web, as the database assists in the calibration of the Deep AutoEncoder. These resumes were taken from different Job Categories and subcategories (around 30 subcategories).

### Data Preprocessing

The data was transformed into an acceptable format to enable calculations, for example, vectors. A Bag Of Words was created. This Bag of Words contained all the words in all the documents except the words considered to be meaningless, for example, the words: the, a, over, and the like.

Using an algorithm, all of the resumes were compared to the Bag of Words. For every resume, a count vector was created, that counts every time occurs one of the words in the bag of words. The count vector (2000 words for instance) is then compressed into two double numbers that constituted the coordinates of a Candidate Point.

The Purpose of the Deep Autoencoder (DA) is similar to a Principal Component Analysis (PCA). PCA is a statistical technique that enables to associate to a data entry a representation in statistical meaningful Axis (the axis that have the more variance).

A data entry is associated with only the contributions on the most meaningful axis, and the Inverse PCA process is used to regenerate a data entry point very close to the original one. This process corresponds to a compression with loss of information, as described in two phases: Encoding (from Original data entry to contributions on most relevant axis); and, decoding (from contributions to a Data point similar to the original one).

The DA works in a similar way, though does not provide exactly the same axis, but still enables us to do some data compression.

The DA is built using a Deep Belief Network with Restricted Boltzmann Machines (RBM) as neurons to simplify the process, that means a Neural Network with 4 or 5 layers of RBM to represent the encoding part (half of the Neural Network) and a bottleneck consisting of a few Neurons, to maintain the meaningful contributions.

For example, only two contributions were kept, which provided the coordinates of the Point that represents the Candidate.

To calibrate the entire DA, the retrieved data was used to calibrate the system. A set of documents was constructed from the bag of words, e.g., 2000 Words. For each document, a count vector of 2000 words that counts every time one of the words of the Bag of Words appears. The count vector serves as entries of the Auto Encoder. Every Neuron in every layer has its specific weights for the calibration. In order to calibrate those weights, the reconstructed Data computed by the AutoEncoder is compared to the Original Data. An error function is computed, as a function of the errors on every Data Entry and try to minimize this error by changing the neurons weights.

According to Geoffrey Hinton, one Efficient Solution would be to Compute the Weights of the Encoding part using RBM calibration, and then use Backpropagation for the decoding part (initializing the weights of the Neurons in a symmetric way to the one computes for the Encoding RBM). Machine Learning general considerations are applied to enable a fast and sure convergence, to prevent overfitting (the model is so well calibrated to the test data that to any other data the processed output will be wrong with a high probability) or under fitting as well. This calibration will be done with data retrieved from the Net.

BeautifulSoup with Python is used for data retrieval/parsing. DeepLearning4j with Java to design NeuralNetworks is used for Data Preprocessing, vectorization, Neural Networks design, Distributed Computation on GPU. Octave is used for Testing Hinton Code for Deep AutoEncoders.

With the aforementioned calibration complete, new text data is introduced and the Encoder provides two numbers that will be the coordinates of the Points. A graphical representation can be associated with the selected text documents. The selected text documents will be translated into a map.

Grammar Module 210c. The grammar module analyzes grammar in the text in accordance with the following processes:
1. The verbal content of the user's response is measured for pragmatic and/or semantic accuracy.
2. The verbal content of the user's response is measured for the average amount of letters per word.
3. The verbal content of the user's response is measured for the average amount of syllables per word.
4. The verbal content of the user's response is measured for the average amount of words per sentence.
5. This may for example make use of an API 210x for accessing verbal grammar. The engine 210 assigns a score to this verbal grammar.

The engine 210 performs multiple verbal analysis assessment methods. While some of the above mentioned verbal analysis parameters used by the system may be based on third party (commercial or open source) technologies, for example NLP (Natural Language Processing) and other speech recognition technologies, and text analysis tools (e.g., Web Speech Recognition API; Nuance Dragon Naturally Speaking SDK; Whitesmoke Writer), accessed via the API 210x, the engine 210 also includes a scoring module 210d, which functions as a scoring system. The scoring module 210d scores by providing a performance rating and score. The scoring is based in part on the output from modules 210a and 210b, detailed above, as well as the above listed APIs 210x. Every single question within the system and its respective response analysis is based on various algorithms, each question and its own method for analyzing the answer quality (as seen in the examples above). The algorithms that define the scoring scheme of the answers provided to each of the questions asked by the system, account for possible motives and/or intentions of the stated question. As a result, the verbal analysis can better assess the desired outcome of the answer. Moreover, the verbal analysis engine 210 provides standards or controls, representing the best or top scoring answers per occupation, and their structure set, or the way to answer each specific question.

### Non-Verbal Analysis Engine 212

The non-verbal analysis engine 212 functions to analyze various traits, mannerisms, and behaviors of the user (e.g., interviewee), and provide a score for these non-verbal actions and behaviors. The non-verbal analysis engine 212 utilizes the following parameters in determining its score:

1. Non-Verbal Analysis Parameters:
a) Physical Feedback: Any musculo-skeletal body gesture or movement (including micro-facial) that may reveal clues as to possible unspoken intention or feeling that may be analyzed for evaluating the candidate performance). The user's non-verbal input is analyzed by at least one parameter including but not limited to the following list.
   1) Eye Gaze (Recording the candidate point of gaze movement)
   2) Facial expressions (Tracking the candidate's facial features and interpreting his emotions) Posture analysis
   3) Movement analysis including hand gesture analysis.
2. Physiological Feedback
   a) Bio-feedback
   b) Breathing rate
   c) Heart rate
   d) Blood Pressure
   e) Skin Conductance

A module 212a for analyzing Eye Gaze is within the engine 212. Eye Gaze or Eye Contact is a form of nonverbal communication that can convey information about any of the below parameters (non-exhaustive list). Through images received from the camera 122a of the computer 122 of the user (e.g., interviewee), the engine 212 predicts a user's eye gaze (eye sight directions) based on an eye object detection mechanism of the system, or an API 212x, such as. e.g. Camgaze.js). Eye gaze data is based on a pair of two-dimensional vectors that represent the direction of each of the candidate's eyes. The eye gaze direction data is sampled and saved in the storage. A list of parameters that the eye gaze may be able to assess: authenticity (truthfulness), and focus or distraction.

Scoring for the eye gaze analysis depends on one or more of the following:
a) The “gaze bias value”: the value and/or measurement of the amplitude of the gaze vectors). Note, this measurement may be based on a variation of modifiable mathematical formulas, in order to best calculate the value of the eye gaze.
b) Any particular threshold (which has been defined in the system) on which the amount of time the gaze bias value may be above. Otherwise stated, the eye gaze measurement system monitors the amount of time in which a candidate gazes at a particular direction, or changes gaze directions for example (downwards; upwards)

Facial expressions. A module 212b within the Non-Verbal Analysis Parameters, Facial expression is defined by the positions of the muscles beneath the skin of the face. The system tracks the micro-facial movements (e.g., facial gestures) and outputs a list of related coordinates. The coordinates reflect insights that depict the candidate's emotions. The system is mainly based on an API 212x e.g. clmtrackr, Affdex API. Emotient API, that can detect and defines micro-facial gestures. The micro-facial coordinates and corresponding emotional data are saved and analyzed in the storage 210. The candidate's facial expression may convey information about the any of the following example emotional states: Anger, Joy, Sadness, Surprise, Pride, Fear, Disgust, and, Boredom.

The score for this analysis, as calculated by the scoring module 2121f depends on: a) the emotions the candidate has shown when answering a question; b) the time an emotion is expressed; and, c) the amount of time each emotional state is expressed.

Posture analysis by a posture analysis module 212c: Posture is defined by the position and orientation of either a specific body part or of the position or orientation of the entire body. Body parts associated with posture are taken into consideration to deduct both personal traits and/or emotional states, as provided in a list including, Head, Chest, Shoulders, Arms, and, Hands.

The candidate's posture may convey information about the following personal traits, including, for example, personality, confidence, submissiveness, and, openness.

The candidate's posture may convey information about the following emotional states: anger, joy, sadness, surprise, pride, fear, disgust, and boredom.

According to body space coordinates, the system is able to understand and determine the candidate's posture. According to the posture, the system is able to interpret at least one of the above mentioned traits or emotional states, by comparing the posture analyzed by the system to posture analysis research (formulas, models, theories) stored within the system. The scoring module 212f assigns a score for body posture based on this comparison. e.g. the closer the user's posture is to an accepted stored posture a higher score will be assigned. Each time such emotional state or trait is detected, it is saved in the storage and triggers an event into the system, and may respond or react respectively, e.g. trigger another pre-recorded segment of the video for presentation. Behind the emotional states or traits occurrence, the scoring module 212f collects also metadata on them, to adjust the score based on the following list, which includes: a) the cause of the occurrence (posture); b) the amplitude of the emotional state or trait; c) the time when the emotional state or trait has been detected; d) the amount of time the emotional state has been detected.

The system 100′ is able to react differently according to the emotional state(s) detected during the interview. This analysis produces a score that is taken into account for the candidate performance report.

Movement analysis by a movement analysis module 212d: Movement is defined by the actions of the body parts over time, including hand gestures. When moving, body parts are taken in consideration to deduct either personal trait or emotional state.

The list of body parts for which movement is analyzed by the movement module 212d includes, for example: head, arms, and hands.

The candidate's body movement conveys some information about his emotional states, for example: anger, joy, sadness, anxiety, interest, fear, inhibition, depression, pride, shame.

According to the body space coordinates, the module 212d is able to understand and determine the movement. According to the movement, the system is able to interpret at least one of the emotional states mentioned above. Each time such emotional state is detected, it is saved in the storage 220 and triggers an event into the engine 212. Behind the emotional states or traits occurrence, the module 212d produces a list. The list includes: a) the cause of the occurrence (here movement); b) the amplitude of the emotional state or trait; c) the time when the emotional state or trait has been detected: and, d) the amount of time the emotional state has been detected.

The module 212d is able to react differently according to the emotional state(s) detected during the interview. This analysis is provided to the scoring module 212f, that produces a score that is taken in account for the candidate performance report. This score for the movement analysis is based on the above mentioned parameters and is added to the present overall score (computed by the CPU 202) obtained based on the parameters detailed above.

Physiological feedback of module 212e. Any physiological manifestation of the body that can be measured. According to these parameters the system can evaluate candidate's feeling or emotional state, listed as follows. The list includes, for example: stress level, lies, anxiety, fear, and, anger.

Behind the feeling or emotional state, the system 100′ collects also metadata on these psychological manifestations, including, for example: a) the cause of the occurrence (here physiological); b) the amplitude of the emotional state or trait: c) the time when the emotional state or trait has been detected; d) the amount of time the emotional state has been detected.

The engine 212 is able to react differently according to the emotional state(s) detected during the interview. This analysis, as interpreted by the scoring module 212f, produces a score that is taken in account for the candidate performance report (overall present score, as produced by the CPU 202).

The scores from this engine 212, which make up the overall score for a candidate performance report, may be weighted to emphasize greater or lesser importance for this characteristic.

The system 100′ may be customized to place more importance/significance to one engine/module or parameter over another, whether it be for verbal or non-verbal analysis, and physical or physiological parameters. As such, the system 100′, provides a back office (i.e. management system) which may allow for the adjustment and administration of the system 100′.

### Vocal Analysis (Intonation) Engine 214

The Vocal Analysis (Intonation) Engine 214 functions to analyze various traits, mannerisms, and behaviors of the user (e.g., interviewee), via the audio portion of the interview, as stored in audio files, and provide a score for the vocal analysis. The vocal analysis engine 214 utilizes the following parameters in determining its score.

Vocal Intonation-Module 214a. The sonic characteristics and prosodic features of the user's voice are analyzed to assess the user's emotional state including but not limited to happiness, sadness, confidence, anxiety or excitement. This may for example make use of an API, which can assess vocal intonation. The system assigns a score to this vocal intonation, via the scoring module 214d.

Vocal Stress-Module 214b. The he sonic characteristics of the user's voice are analyzed to assess the veracity and authenticity of the spoken content, e.g. truth. This may for example be analyzed via an API 214x, which can assess vocal stress. The engine 214 assigns a score to this vocal stress, via the scoring module 214d.

Verbal Clarity and Coherence-Module 214c. Verbal clarity and coherence is a measurement of the average volume and sonic dynamic range of a user's speech and/or the vocal articulation of a user's speech. This may for example, make use of an API 214x, which can assess verbal clarity and coherence. The scoring module 214d assigns a score to this verbal clarity and coherence.

Other parameters analyzed by the vocal analysis engine 214 include, for example, the following:

Response Time-Response Time is the measurement of the duration of time after an individual question is asked by the system's interviewer and the second in which the user begins to respond in words to the specific question.

Answer Length-Answer Length is the measurement of the overall number of words used in each response to each individual question.

Answer Duration—Answer Duration includes a) a measurement of time the user requires to formulate a response in its entirety; b) a measurement of the time starting with a user's first word in a response until the last word is used in response to each question; and, c) a measurement of time starting with a user's first word used in response to a specific question until a pre-determined allotted length of time is completed.

Speech Pace—Speech pace is the average rate of user speech measured in words per specific duration of time, including but not limited to minutes and/or seconds. Speech pace is the comparison of the previously defined answer length to answer duration. This may for example make use of an API 214x, which can assess verbal speech pace.

Fluidity—Fluidity includes: a) The verbal content of the user's response is measured for pauses in speech, and/or repetition of words or non-word sounds; b) The previously defined response time, answer length, answer duration and/or speech pace are compared in relation to other candidates. Fluidity, may, for example, make use of an API (application programming interface), which can assess verbal fluidity. The system 100′, via the scoring module 214d assigns a score to this verbal fluidity.

### Interaction Engine 216

The Interaction Engine 216 is responsible for providing the user (e.g., interviewee) a life-like interview experience, as the interviewer asks professionally relevant questions to the user (e.g., interviewee) 122, the questions having been selected and provided as a list of questions relevant to the position being interviewed for, when the HR administrator or other person in charge of the interview, sets up the interview. This engine 216 is programmed to operate based on audio received from the user (e.g., interviewee) 122 during the interview, for example, in real time, as input into the engine 216 by the microphone, e.g., microphone 122b, associated with the user, e.g., the user's computer 122. The engine 216 parses/scouts the vocal input from the user 120, for specific phrases, keywords, engrams, and/or one or more keyword combinations, that the engine 216 can convert to commands, to trigger the next question, cause selection of this next question, and/or determine that the questioning should end. Additionally, the engine 216 is programmed to determine audio pauses, periods of silence in the audio, still sounds, slowing down of speech indication the conclusion of an answer, or other vocal intonations indicating the end of an answer or signs of the user becoming tired or bored, as received from the user, to form and issue commands for triggering the next question, and selection thereof, as well as ending the questions of the interview. Also, the interaction engine is programmed to analyze the aforementioned audio input from the user 122, for example, by contextually analyzing the user's answer, and select the next question, from a list of possible questions (established when the interview was set up). By contextually analyzing the answer provided by the user 122, the system 100′ conducts a contextually relevant interview dialogue, between the interviewer, i.e., audio and video recordings of the interviewer, or the live interviewer 140, both recorded and live interviewers as displayed on the computer 122 of the user 120. The aforementioned analysis of the audio input, is, for example, backed up by the Verbal Analysis Engine 210, which performs similar operations on the text of the audio of the interview, which this engine 210 has converted from audio to text via an API 210x, as detailed above.

The interaction engine 216 takes the user's vocal inputs (e.g., answers, comments, reactions, responses, and counter-responses, and selects question types (based on the contextual analysis of the audio as received from the user), using both Questionary type and Interactive type monologues. The engine 216 then plays the appropriate pre-recorded questions of the interviewer of the selected interview of the system 100′. The interaction engine 216 uses these commands to pull/trigger the most relevant pre-populated, pre-recorded interviewer questions, (e.g., recorded video questions), from the total of the selected questions (e.g., recorded video questions), these questions selected from a list of possible questions, the list established upon setting up the interview, systematically (playing the most relevant pre-recorded video clips, either questionary type monologues or interactive type monologues), and based on the logic scheme and rule based system of Table 1, in order to best counter-respond to the user's (interviewee's) responses and conduct a seemingly contextually relevant interviewing dialogue with the individual conducting the interview simulation.

### Setting Up and Conducting Interviews

In order to provide a user (job seeker or job candidate) with the possibility to conduct a fully automated interactive job interview, the system 100′ first utilizes/plays pre-recorded audio-videos of a human interviewer (either and/or a real hiring manager; an actor posing as a recruiting manager; or possibly a public figure/personality), which asks professionally related questions to be addressed by the user. Note, the aforementioned pre-populated audio-video recordings of the human interviewer used by the system 100′ include two sets/types of monologues, which together provide users of the system with a contextually intelligent and life-like interactive interviewing experience. These two sets of monologues, questionary type and interactive monologues are described below.

Questionary type monologues are common, and less common with professional related questions asked within an interview. They comprise a vast set of both generic and occupation specific questions. Note, generic type interview questions are more generalized forms of questions, that can possibly be relevant for nearly all occupational fields and professional roles/positions. All types of monologues used by the system are based on extensive and ongoing research conducted on the human resources industry and specifically, the questions and interactions displayed by hiring professionals and recruiting managers during a professional interview. This research is based on both on-line and offline resources i.e., private and/or public articles, books, research papers, and videos, as well as physical on-site observations. Question type monologues do not only emphasize the different types of questions being asked in a professional interview, but also include the way in which the interviewer conveys or should convey each of the proposed questions, e.g. mood, tone of voice, body language, and the systematic hierarchy of stated questions, e.g. which questions should preferably be asked at the beginning, in the middle or at the end of the interview session.

Interactive type monologues are used in order to create a more realistic interviewing experience. The Interaction Engine 216 incorporates pre-recorded interviewer reactions, which are referred to as “wild card” reactions. These audio-visual reactions are based on a logic scheme and rule based system meant to counter-respond to various typical and mainly verbal statements/comments/reactions/responses made by the user (which are not considered as answers), and as would be incurred in a real-life conversation setting and professional interview dialogue. The interactive type monologue scheme is not only designed to counter-respond to the user's verbal and non-verbal inputs more naturally, but also to adjust the system's responses in real time, providing a heightened sense of conversational realism. The “wild card” rule based system is described in Table 1.

In order to provide returning users, (e.g. users utilizing the system 100′ multiple times) an authentic interview experience, both monologue types presented above contain a number of varied pre-recorded audio-video options, representing similar category questions, or counter-responses, however containing different script monologues and acting styles by the system's interviewer. These aforementioned varied pre-recorded video options are accurately and schematically programmed within the Interaction Engine 216, to provide a better sense of natural authenticity and realism to the system, so that users will be less likely to be asked the same questions multiple times over, or receive the same counter responses multiple times over.

Both type of monologues presented by the system, i.e., Questionary and Interactive, may be administered by the system's 100′ interviewer in the English language (in the form of pre-recorded videos). However, language restrictions are not intended. The system 100′ is meant to accommodate a large geographic audience, and as such is able to work in both English as well as many other languages. Language compatibility of the system 100′ not only represents monologues stated by the system's 100′ interviewer's over audio-video recordings, but may also represent or be represented within textual messages. (either technical/non-technical or marketing related) instructions, explanations, and other graphic user interface elements demonstrated by the system 100′.

All pre-recorded audio-videos of a human interviewer used by the system 100′ are specifically filmed, to fit the desired effect/background/setting of a real/life-like professional interview.

The interviewer, and audio recordings of the interview by the interviewer (human individual playing the part of the interviewer), are not limited to a single human individual. The system 100′ uses pre-recorded videos of various human individuals (e.g. real hiring manager(s), actor(s) posing as recruiting manager(s), public personalities, to provide for a more authentic and diversified interviewing experience for the user (e.g., interviewee) 120. Authenticity is thus (also) achieved by casting the most suitable human interviewers used by the system 100′, in which could possibly best fit the role and/or mimic the genre of the desired interviewer type, and interview setting. These casting decisions include but are not limited to the gender of the interviewer (male or female); age (younger or older); attire (formal or casual); type of language spoken, and any related ethnic representation. The aforementioned interviewer types/personas are used to best represent the desired occupation/position/professional role in which the user is being interviewed in. As such, these personas may be selected in advance (prior to using the system) either by a job seeker utilizing the system to practice his/her interviewing skills, or by an organization (private/public companies/firms/corporations/recruiters) for the purpose of conducting/hosting a professional interview for a job applicant, in-order to determine the applicant's compatibility for the position/role, and depending on the desired outcomes and/or goals of the interview, what occupation/role/position is to be filled by the job applicant (e.g., user or interviewee 120) or to be practiced by a job seeker.

The setting/background: the set/location in which the interview takes place in (either filmed within a specific place or designed within a studio to depict a specific location) directs both the general mood/environment, as well as, and is in line with the general tone of interview. As such, interview locations filmed for, and used by the system 100′, and seen by the user via audio-video, include but are not limited to the following locations: professional office; a cafe/restaurant; a conference room; a lounge: or any other possible location that may be customarily used in real-life to conduct an interview.

Telephone (phone) interview settings are such that a fully automated interview is conducted by allowing a user to view and interact/converse with the system's 100′ interviewer via pre-recorded videos. It is of importance to clarify that the intended interviewing experience of the invention does not restrict its users to this main and unique yet single form of interview experience. Additionally, the system 100′ also allows users to conduct a phone interview (an interview which is conducted over a two way calling solution), either by a job seeker utilizing the system to practice his phone interviewing skills, or by an organization (private/public/firms/corporations/recruiters) for the purpose of conducting/hosting a professional phone interview for a job applicant, in-order to determine the applicant's compatibility for the position/role.

Phone interviews are customarily used as a preliminary/initial job applicant compatibility screening method, usually conducted after the resume filtering process, in order to assess which job applicant to invite/call in for a formal interview.

An example telephone interview method is as follows. First, the automated interactive phone interview is enabled by the system 100′. The system 100′ allows users (e.g., interviewees) to select the phone interview option, as opposed to a regular interviewer-interviewee option. Next, as the user selecting the regular interviewer-interviewee option would be able to select the type of occupation and possible setting, and language of the system, so would the user utilizing the phone interview setting. Finally, once the phone interview setting has been selected the user is given the ability to enter his/her phone number.

It should be noted that the user may enter any number which the system has geographic coverage over. The user may enter the number of any type of working phone. A “telephone” or “phone” as used herein, refers to any device providing a telephony solution either IP (Internet Protocol) or PSTN (Public switched telephone network) based, either via landline, over 3/4G. LTE, or any other form of infrastructure enabling a two-way communication.

Any type of handheld device may be used for the phone interview using the system, e.g. smart-phones, tablets, laptops, and the like. The user 120 may be required to opt-in to the system 100′ as requested under the legislation and regulations of the carrier and or the region in which the user resides in. The opt-in option may be in the form of a text message, and or short-code response, and/or any other method deemed optional according to the legislative body/governance. Age restrictive measures will also be followed according to the regulatory measures set by either the carrier and/or the region in which the user resides in.

The opt-in process also validates that the number entered by the user belongs to him/her and that no error was incurred when the number was entered. The opt-in and/or number entered by the user is usually connected to the user's specific system profile/account, for case of identification, and for additional purposes, i.e., phone interview performance analysis.

After opt-in (if required), the user may begin the phone interview session. The session may begin either with the system calling the number provided by the user, and/or playing a video-recording on an interviewer dialing a number, and trying to make a phone call (insinuating that the call is intended for the user). The system 100′ will take a number of measures to verify that the call goes through and has been answered by the user (e.g., interviewee), otherwise the system 100′ will retry a few times, and/or apply other action schemes to best address the situation.

Once the uses picks up the phone, the user will be able to hear and see (if s/he is in front of a computer screen), that the interviewer is conducting an interview with him/her. The user may now converse with the interviewer over his/her phone. Both monologue types and methods of response used by the system, are applicable and are using to conduct the phone interview session as well. At the end of the session, the user will be able to verify the performance analysis.

The analysis is based on the same verbal assessment method conducted during the regular interviewer-interviewee session.

Attention is now directed to FIGS. 3, 4A and 4B, which show flow diagrams detailing computer-implemented processes in accordance with embodiments of the disclosed subject matter. Reference is also made to elements shown in FIGS. 1A, 1B and 2. The process and subprocesses of FIGS. 3, 4A and 4B are computerized processes performed by the system 100′. The aforementioned processes and sub-processes can be, for example, performed manually, automatically, or a combination thereof, and, for example, in real time.

The process begins at block 302, where the interview is defined. The interview is defined via the HR administration system 112, as an HR administrator, for whose business the interview will be conducted: 1) defines the position, for which interviews will be held; 2) sets the criteria, e.g., the question types for the interview, for example, including scripts from storage 222, and a list of possible specific questions; and, 3) provides a list of candidates, e.g., interviewees, who will be notified and accordingly, invited to interview at their computers, e.g., represented by the computer 122, either recorded (automated), as shown in FIG. 1A, or live, as shown in FIG. 1B.

The process moves to block 304, where the interview is conducted, for example, in real time, via the user computer 122 and it is recorded in video and audio. If a live interview, of FIG. 1B, the interview is conducted by the interviewer 140 via his computer 142, with the interviewer 140 and interviewee 120 being recorded in both video and audio. This video and audio for the interview of the interviewee, and the interviewer in the case of the live interview, is stored at block 306. Optionally, at block 307, the interviewer's audio and video of the interview are stored as audio and video files in storage 220 (FIG. 2).

From block 306 and optional block 307, the process moves to block 308. The stored video and audio for the interview of the interviewee (an interviewer, in the case of the live interview) is now analyzed, at block 308. The analysis is such that an evaluation of the user (e.g., interviewee) 120 is issued, at block 310. The evaluation includes, for example, one or more of: an assigned candidate score; a recommendation/non-recommendation for the user (e.g., interviewee) 120; and, a display of the relevant analysis, for example, in the form of a report.

Turning now to FIG. 4A, block 304 is shown in greater detail. From block 302, the process moves to block 304a. At block 304a, the system 100′, i.e., the interaction engine 216, detects the end of the interviewee's answer to a question, for example, by detecting audio pauses, periods of silence in the audio, still sounds, slowing down of speech indication the conclusion of an answer, or other vocal intonations indicating the end of an answer or signs of the user becoming tired or bored, as received from the audio input from the user (e.g., interviewee) (for example, via the microphone 122b of the user's computer 122).

The answer is then analyzed, at block 304b. This analysis is, for example, contextual, based on the context of the answer, input by the interviewee. The process moves to block 304c, where based on the aforementioned analysis, e.g., the contextual analysis, the engine 216 determines whether more questions should be asked. Should it be determined that no further questions are to be asked, either from the aforementioned analysis at block 304b, or the list of questions for this interview is finished (and there are not any more questions provided for this interview), the process moves to block 306.

However, at block 304c, should more questions need to be asked, the process moves to block 304d, where based on the aforementioned analysis, the next question is selected. This selection is, for example, from a list of questions selected for the interview, at the time the interview is set up, for example, at block 302. The selected question is then asked by the interviewer, to the interviewee, at block 304e. The selected question is either recorded, or live, depending on the interview type, automated or live, respectively. From block 304e, the process returns to block 304a, where it resumes.

Turning now to FIG. 41B, block 308, the analysis is shown in greater detail. At blocks 308a-1, 308a-2 and 308a-3, the engines, verbal analysis 210, non-verbal analysis 212 and vocal analysis 214 engines each perform their analysis. The analysis is then sent to internal scoring modules, as blocks 308b-1, 308b-2 and 308b-3, by each scoring module 210d, 212f, 214d. The respective scores are then sent to the CPU, at block 308c, where a candidate score is computed. The process then moves to block 310, of FIG. 3.

### Machine Learning

### Machine Learning Overview

During the interview, a wide range of features from the different modules are collected and fed into a machine learning system 330 (FIG. 2A), which is then capable of predicting the candidate's compatibility to the proposed job. Features are typically any type of parameter being analyzed during the interview process. i.e., voice intonation, micro-facial gestures, verbal analysis, and the like.

### Dataset Labeling

The system 230 (FIG. 2A) evaluates a candidate's overall interview performance based on the aforementioned features and their respective scores. Features are found within the various modules making up the different engines 210, 212 of the global system, to which the system 230 is directly linked. In order to teach the machine learning system 330 the desired score outcome for each respective feature, individual examiners, such as persons with knowledge in a particular field, may at times be used to help label/score these respective features, based on either a fixed or weighted scale system (example 1-7) per feature, as they review recordings of candidate interviews. The machine learning system 330 thus can adjust and improve its scoring outputs, via its scoring module 232 (FIG. 2A) based on the aforementioned labels/scores.

### Learning

The machine learning system is a neural network with visible unit layers, where features are fed into one or more hidden/internal unit layers, and output unit layers. The neuron units are connected to each other with a defined set of probabilities (activation probabilities). During the learning process, these probabilities adjust themselves so that incoming features may be able to produce predictions closer to the labels/scores at the upper (output) layer. The system 330 uses the backpropagation algorithm to train the system, but is not limited to this methodology alone.

### Scoring Logic

Each of the modules contained within the Verbal and Non-verbal engines are scored individually based on a relative weighted scoring algorithm, and weighing each of the features found within these modules respectively. A feature may receive a heavier weight over another based on its level of validity, reliability, relevancy, and probability in predicting a candidate's compatibility for a particular job. A trade-off algorithm may be applied to help determine the weight classes needed per each feature, the system may thus also use such an external algorithm API, i.e., IBM Tradeoff Analytics API. Tradeoff analytics can not only help determine and highlight different weight classes; yet may also be used to determine the compatibility level of one candidate over another. Machine learning is applied to the scoring logic by auto-adjusting weights accordingly. The scoring module 232 evaluates the machine learning and any scores produced by the engines 210, 212, to provide a score for the candidate.

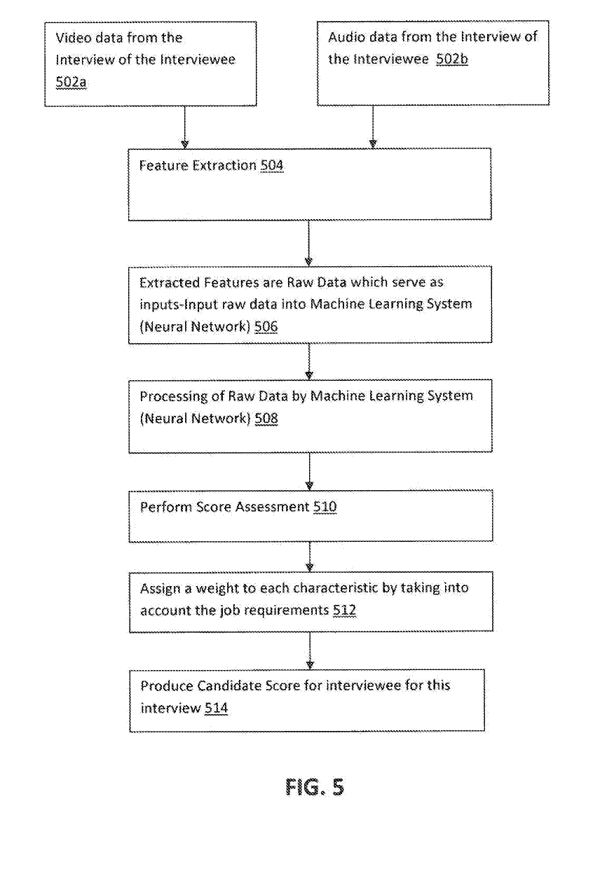

FIG. 5 is a flow diagram of an exemplary process performed by the machine learning system 230 and the scoring module 232. At block 502a recorded video from the interview, and at block 502b, recorded audio from the interview, both of the interviewee, is analyzed and features are extracted from the video and audio, at block 504. These extracted features, include for example, facial expression features, eye gaze, and voice inflections, words spoken and their order, which define raw data, as per block 506. This raw data is input into the machine learning system, e.g., neural network, for processing, at block 508. Processing is such that the raw data is used to determine various characteristics of the interviewee, such as, openness, engagement, motivation, sociability, and the like.

The process moves to block 510, where a score assessment of the determined characteristics is made by the scoring module 232, which at block 512 assigns a weight to each characteristic by taking into account the requirements of the position (job) being interviewed for. The process moves to block 514, where the scoring module 232 produces a candidate score for the interviewee from the interview.

While the invention has been shown and described above for employment and job placement for the professional recruitment industry, the engines, methods, and systems may also be used in other industries and functions including but not limited to the following: corporate training, sports, including sports psychology, education, sales, law-enforcement and security.

The implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

TABLE 1

| Candidate | Answer | | Metric | | |
|---|---|---|---|---|---|
| Answer | Type | Description | Rule | HR Reaction/s (flow in case no response) | |
| No answer | Duration | No sound | 10 sec | 1. | HR asks the same question |
| | | input | have | | differently. |
| | | | passed | 2. | HR states: Perhaps I'll simply begin |
| | | | | | and explains procedure. |
| | | | | 3. | HR states: I'm sorry, can you please |
| | | | | | speak up? |
| | | | | 4. | Modal dialogue: Your interview |
| | | | | | session has began, we are not |
| | | | | | detecting any voice input. Please |
| | | | | | check that your microphone is |
| | | | | | working properly. |
| | | | | 5. | HR asks the next question. |
| Too short | Duration | Short answer | Answer is | 1. | HR asks the candidate to elaborate. |
| | | is provided | below 10 sec | 2. | HR moves on to the next question. |
| Too long | Duration | Long answer | Answer is | 1. | HR interrupts the candidate and |
| | | provided | above 3 min | | moves on to the next question. |
| Unrelated | Irrelevant | Phrase does | Answer is | TBD | |
| | content | not exist in | illogical | | |
| | | hard coded | | | |
| Incoherent | Gibrish | Phrase does | Text can't | 1. | HR asks candidate to clarify, the |
| | content | not exist in | be | | below HR responses are random/ |
| | | hard coded | deciphered | | not in hierarchy. |

| | |
|---|---|
| 1. | I'm sorry, can you please |
| | speak up. |
| 2. | Pardon, but I can't seem to |
| | understand what you are |
| | saying, you'll need to speak |
| | up and talk more clearly. |
| 3. | Sorry, but I can't seem to |
| | make out what you are |
| | saying, I'll have to ask you to |
| | speak more coherently. |

| | | | | | |
|---|---|---|---|---|---|
| Profane | Vulgarity | 1 or more | Hardcoded | 1. | Perhaps I'll simply begin and |
| | content | insults | keywords | | explains procedure. (Same as #2 |
| | | | | | from No answer). |
| | | | | 2. | I'm sorry but your interview session |
| | | | | | has began, so let's try this once |
| | | | | | again |

| | |
|---|---|
| 1. | HR - repeats question from |
| | random list. |

| | | | | | |
|---|---|---|---|---|---|
| | | | | 3. | Modal dialogue: Your interview |
| | | | | | session has began, profanity is |
| | | | | | explicitly prohibited. Please respect |
| | | | | | your interviewer. Retry/End session |
| | | | | 4. | Modal dialogue: Your session has |
| | | | | | ended due to profanity. |
| Dismissed | Requests | Candidate | Hardcoded | 1. | HR states randomly one of the |
| | content | requests | phrases | | below |

| | | |
|---|---|---|
| (see below) | 1. | “ok let's move on to the next |
| | | question” |
| | 2. | “let's skip this and move on |
| | | to another question” |

| | | | | | |
|---|---|---|---|---|---|
| Puzzled | Clarifications | Candidate | Hardcoded | 1. | HR answers with advice on how to |
| | content | asks for more | phrases | | best answer this question. |
| | | details | | 2. | HR answers with advice on how to |
| | | (see below) | | | best answer this question in a |
| | | | | | different way. |
| | | | | 3. | HR moves on to the next question. |

| | | | | |
|---|---|---|---|---|
| Too fast | Speed | Candidate | TBD | TBD |
| | | speaks too | | |
| | | fast | | |
| Too slow | Speed | Candidate | TBD | TBD |
| | | speaks too | | |
| | | slow | | |

### Answer/Response Types by the Candidate:

There are two main possible response types/categories by the candidate.
1. Good answer: Any answer which does not fall into any of the odd reaction cases seen within Table 1.
2. Odd reaction: Any of the response candidate answers described in Table 1.

### Conversation Flow:

1. Interviewer asks question
2. User either.
   a) Answers
   b) Responds with odd reaction
3. Interviewer's counter response
   a) If there was a good answer=>the system's interviewer moves on to the next question.
   b) If there was an odd reaction=>see Table 1.

1. A computer-implemented method for evaluating a subject, comprising:
providing, in a prerecording delivered over a communications network to a display device associated with a subject, at least one statement, as integrated audio and video, to the subject;
recording the subject in both audio and video in responding to the statement,
analyzing the audio and video for at least one characteristic of the subject; and,
providing an evaluation of the subject based on the analysis of the at least one characteristic.

2. The method of claim 1, wherein the at least one statement includes at least one prerecorded interview question which is being presented by a visible interviewer in the prerecording, in an interview with the subject.

3. The method of claim 1, wherein the at least one prerecorded interview question includes a plurality of prerecorded interview questions which are being presented by the visible interviewer.

4. The method of claim 3, wherein the plurality of prerecorded interview questions are defined by a list and are of multiple question types, the questions selected prior to the interview based on the position for interview is being conducted.

5. The method of claim 4, wherein the order of presenting the prerecorded interview questions is in accordance with an analysis of the audio and video of the answer to the previous prerecorded interview question.

6. The method of claim 5, wherein the presenting the prerecorded interview questions is terminated in accordance with an analysis of the audio and video of the answer to the previous prerecorded interview question.

7. The method of claim 6, wherein the presenting and terminating of the presenting of the prerecorded questions is performed in real time.

8. The method of claim 6, wherein the analyzing the audio and video for at least one characteristic of the subject, is performed on recorded audio and video files taken of the subject while responding to the questions.

9. The method of claim 6, wherein the evaluation of the subject is presented as at least one of: a candidate score for the subject, and, a recommendation or non-recommendation of the subject for the position for which the interview was conducted.

10. The method of claim 6, wherein the display device associated with the subject is a computer including a monitor linked to the communications network, a camera for recording the video associated with the subject and a microphone for recording the audio associated with the subject.

11. A system for evaluating a subject, comprising:
first storage media for storing interviews for at least one position including a plurality of prerecorded questions for presentation to a subject over a communications network to a display and audio and video recording device associated with the subject, as integrated audio and video;
a processor; and,
second storage media storage media in communication with the processor for storing instructions executable by the processor, the instructions comprising:
presenting prerecorded questions as integrated audio and video to the subject over the communications network to the display and audio and video recording device associated with the subject;
recording the subject in both audio and video in responding to the prerecorded questions;
analyzing the audio and video for at least one characteristic of the subject; and,
providing an evaluation of the subject based on the analysis of the at least one characteristic.

12. A computer usable non-transitory storage medium having a computer program embodied thereon for causing a suitable programmed system to provide an evaluation of a subject, by performing the following steps when such program is executed on the system, the steps comprising:
obtaining, from storage media, at least one stored prerecorded interview for at least one position including a plurality of prerecorded questions for presentation to a subject over a communications network, to a display and audio and video recording device associated with the subject, as integrated audio and video;
presenting prerecorded questions as integrated audio and video to the subject over the communications network to the display and audio and video recording device associated with the subject;
recording the subject in both audio and video in responding to the prerecorded questions;
analyzing the audio and video for at least one characteristic of the subject; and,
providing an evaluation of the subject based on the analysis of the at least one characteristic.

13. A method for interviewing a subject comprising:
obtaining a plurality of prerecorded questions for presentation to an interview subject over a device linked to a communications network in an integrated audio and video format;
presenting a first question from the plurality of prerecorded questions to the subject via the device;
analyzing at least the audio received from the subject via the device over the communications network, for the end of the answer to the first question; and,
based on the analysis, performing at least one of: presenting a subsequent question from the remaining plurality of prerecorded questions, or terminating the presenting of the prerecorded questions.

14. The method of claim 13, wherein the analyzing includes further analyzing at least the audio received for the answer, and based on the further analysis, determining which question of the remaining plurality of prerecorded questions is to be presented to the subject.

15. The method of claim 13, wherein the analyzing includes further analyzing at least the audio received for the answer, and based on the further analysis, determining to terminate the presenting of the prerecorded questions.

16. The method of claims 14 and 15, wherein the further analysis includes a contextual analysis of the answered prerecorded question.

17. The method of claim 13, wherein the presenting the first question from the plurality of prerecorded questions to the subject via the device; and the analyzing at least the audio received from the subject via the device over the communications network, for the end of the answer to the first question, are performed in real time.

18. The method claim 13, wherein the device associated with the subject is a computer including a monitor linked to the communications network, a camera and a microphone.

19. A system for evaluating a subject, comprising:
first storage media for storing interviews for at least one position including a plurality of prerecorded questions for presentation to a subject over a communications network to a display and audio and video recording device associated with the subject, as integrated audio and video;
a processor; and,
second storage media storage media in communication with the processor for storing instructions executable by the processor, the instructions comprising:
presenting a first question from the plurality of prerecorded questions to the subject via the device;
analyzing at least the audio received from the subject via the device over the communications network, for the end of the answer to the first question; and,
based on the analysis, performing at least one of: presenting a subsequent question from the remaining plurality of prerecorded questions, or terminating the presenting of the prerecorded questions.

20. The system of claim 19, wherein the instructions additionally comprise: further analyzing at least the audio received for the answer, and based on the further analysis, determining which question of the remaining plurality of prerecorded questions is to be presented to the subject.

21. The system of claim 19 wherein the instructions additionally comprise: further analyzing at least the audio received for the answer, and based on the further analysis, determining to terminate the presenting of the prerecorded questions.

22. The system of claims 20 and 21, wherein the further analysis includes a contextual analysis of the answered prerecorded question.

23. A computer usable non-transitory storage medium having a computer program embodied thereon for causing a suitable programmed system to provide an evaluation of a subject, by performing the following steps when such program is executed on the system, the steps comprising:
obtaining a plurality of prerecorded questions for presentation to an interview subject over a device linked to a communications network in an integrated audio and video format;
presenting a first question from the plurality of prerecorded questions to the subject via the device;
analyzing at least the audio received from the subject via the device over the communications network, for the end of the answer to the first question; and,
based on the analysis, performing at least one of: presenting a subsequent question from the remaining plurality of prerecorded questions, or terminating the presenting of the prerecorded questions.
